(19) United States
(12) Patent Application Publication
(10) Pub. No.: US 2025/0083932 A1
(43) Pub. Date: Mar. 13, 2025

(54) FOUR POST WORKPIECE LIFT FOR SPORTSVEHICLES AND SMALL MACHINES

(71) Applicant: Yves Brouillette, Collingwood (CA)

(72) Inventor: Yves Brouillette, Collingwood (CA)

(21) Appl. No.: 18/564,828

(22) PCT Filed: Jun. 15, 2023
(86) PCT No.: PCT/CA2023/050829

§ 371 Date: Nov. 28, 2023

Related U.S. Application Data
(60) Provisional application No. 63/352,771, filed on Jun. 16, 2022.

(51) Int. Cl. B66F 7/04; B66F 7/26; B66F 7/28

(52) U.S. Cl. CPC B66F 7/04; B66F 7/26; B66F 7/28

(57) ABSTRACT

A 4-post workpiece lift with a cuboid structure including a rectangular upper frame supported on 4 independent corner posts each providing lift to transverse lifting rails and workpiece runways. The upper rectangular frame members with depending independent legs provide solid upper anchor points to lift one or the other end of the workpiece off the runways to complete required work and at least one workpiece runway is slidable on its corresponding rails to provide an in-use variable width 2 runway support. The invention is readily adaptable to very narrow to much wider machines of different sizes and types with varied wheel or track spacings and can also be used to raise the same workpieces to allow for storage space under the lift runways. The rigidity of the cuboid structure lift framework would allow safe displacement of the lift on dolly wheels, providing flexibility in the workplace.

### CROSS REFERENCE TO RELATED APPLICATION

This application is a national stage entry of PCT/CA2023/050829 filed Jun. 15, 2023, under the International Convention and claiming priority over U.S. Provisional Patent Application No. 63/352,771 filed Jun. 16, 2022.

### FIELD OF THE INVENTION

The present invention generally relates to an improved 4-post lift adapted for use in repair and maintenance of smaller vehicles and power equipment such as ATVs, side by sides, motorcycles, lawn equipment, small tractors, snowblowers and the like.

### PRIOR ART

Prior art devices are used for lifting a vehicle for underbody service and repair, or storage. There are many problems and limitations inherent with known automotive lifting devices as they are not typically used in the powersports and power equipment industry, such as safety, functionality, adaptability, overall cost of installation and use.

One such example of a 4-post lift is shown in U.S. Pat. No. 7,143,869 (herein USP '869), now expired. The patent describes a complex mechanism to provide ‘orientation of cables and pulleys to direct the force generated while elevating and suspending a vehicle straight down from the internal top center of each column’. The applicant asserts that “This directional force provides a stable vehicle lift and the columns and runways shield the moving parts from operator contact and protect the parts from exposure thereby increasing thee useful life of the lift”. In doing so, FIG. 2 shows 4 individual posts extending upwards at least the height of a man, and more. These contain and move a ramp lift structure from a low position adjacent the shop floor to an elevated position with the vehicle extending into overhead space beyond the posts. To accommodate larger vehicles such as SUVs and trucks the post plus overhead configuration dictates a very large ceiling height in housing building. Such buildings are typically large industrial or commercial spaces with both broad spans and great ceiling height with a flat roof.

FIG. 8 of USP '869 seems to show an articulating arrangement whereby dolly wheels may be (1) engaged with the floor upon lowering to the limit thereby allowing the lift to be moved, and (2) retracted during elevation of the lift.

The above-mentioned automotive lift is of a common design. It offers good lifting capacity where there is an open area above to raise the work piece to allow access under the runways, and access on both sides of the lift to the runways. However, it does not:
allow use for workpieces of smaller dimensions because of the fixed and wide opening between runways not allowing for proximity to work, and
offer anchor points above for lifting one end of the workpiece to complete work, without the use of jacks limiting clear access to work area and cluttering the work runway surface, and
permit use in smaller work areas. The workplace lift designed for the automotive industry does not offer the adaptability and functionality required in a power sport and small engine repair shop.

In order to service the intended vehicles USP '869 necessarily includes very robust and correspondingly expensive structure.

A similar 4-post lift arrangement is offered at https://liftking.ca/pro-king-12-xlt/wherein which provides immovability of the lift.

Such 4-post lifts are commonly designed for large open spaces and a high lift capacity such as required for a car or truck. As such, they are designed as building-independent free-standing structures which may be added to or removed from pre-existing or custom designed future buildings.

The typical 4-post vehicle lift described above may be designed for, but not limited to, much lighter and smaller 2, 3 and 4-wheeled or tracked vehicles such as recreational vehicles of various types. The results are unsuitable, especially in situations of lighter machines such as lawn mowers, snow blowers, small tractors and the like, where the requirement for proper working height, runway adjustable spacing, accessibility from all sides, proximity to work, and under body inspection and repair can occur frequently and are most often approached looking for a lower cost perspective overall.

As such, power sports and outdoor power equipment repair facilities commonly use lighter weight and smaller scissor lift worktables similar to the Redline 2200 HD UTV/ATV (trademark) lift table so that the vehicle in question may be lifted in a horizontal alignment by the scissor lift itself. Technicians commonly then use jacks or suspend one end of the workpiece from the building structure using a chain hoist, to tilt up one end of the workpiece for completing repairs on an angled workpiece in a more comfortable manner.

This approach relies heavily upon the effective strength and load bearing capacity of a pre-existing building and the care undertaken by the mechanic operating the chain hoist or doing the work. Pre-existing, or even new, buildings and, particularly large and high-ceilinged buildings required for automotive repair, are generally not designed for a downward fixed or moving point load along a single support span on the ceiling or roof structure, particularly as such a building ages. Notably, applying lifting force to one end of a vehicle in for service changes the loading dynamics of the lift itself as well as that of the chain-hoist attachment point both initially and throughout the lift cycle thereby requiring fixation for safety and structural integrity

Typically, utility for service and structural integrity in a scissor lift dictate a generally rectangular interior lifting frame with wheel supporting runways or platform extending the full vehicle length and robust cross-members. All of the lifting frame structure necessarily interferes with the under-body activities required for service and does not offer the ability to make the work table narrow without removing heavy runways or platform extensions, to have a closer reach to work on narrow machines from both sides. In some cases, the workpieces are wider and are placed close to the outer edges of the scissor lift platform making for an unsafe load, more stress on the platform structure, and can be unstable as the base and lift structure of the scissor lift are generally narrower than the work platform.

Other examples are shown in U.S. Pat. No. 4,300,659, particularly at FIG. 1, and in U.S. Pat. No. 9,751,737 wherein a 4-post lift with a rectangular lifting frame including runways is augmented by in-line structure.

In some cases, constant stress imparted on the lifting device from the weight of the vehicle and shop environments weakens the lift and can result in undesirable maintenance and repairs.

In one case, shown in Chinese patent document CN110194424A a 4-post lift appears to be shown with an extremely robust base and a pair of vehicle ramps which may be driven to adopt a non-horizontal working position.

In other cases, it is known in smaller shops such as frequented by smaller and recreational vehicles a non-horizontal working position is achieved by a ceiling-mounted chain block whose lifting hook is connected to the front or back end of the vehicle being serviced and then raised to provide improved under-body work clearance but a 3-point stance (the hook and the opposing wheel pair remaining on the ramp pair).

The above-noted prior art does not address the varied needs of the power sports and power equipment shops. Many types of limited use lifts are required to address the need to properly position the varied types of workpieces for safe and ergonomically correct work access for the technician. The present invention offers many advantages as a single solution.

### OBJECTS

It is an object of the present invention to provide a sturdy and building independent self-contained lift of a 4-post type which is adjustable, inexpensive to manufacture and adaptable, and is simple and safe to use without undue attention.

It is a further object of the invention to provide a lift structure which allows for easy adjustment of runway spacing to accommodate a variety of machines, which provides under body access between runways, having a continuous work platform with no openings when runways are adjusted one against the other.

It is a further object of the invention to provide a lift structure with generally horizontal runways which remain horizontal during the work cycle.

It is a further object of the invention to provide a simple lift structure which can accommodate both horizontal work disposition and a fixed angled work disposition without undue risk of abrupt movements and load failures, by providing fixed lift points from the invention's structure itself.

It is still a further object of the invention to provide a simple lift structure which can provide for underbody access along its working length without interference from the lift platform lateral elements.

It is still a further object of the invention to provide a simple lift structure which is readily adaptable to a change of location without disassembly.

### DEFINITION

In this application ‘independent’ when used in relation to the legs of the cuboid frame structure means securely connected to said upper rectangular frame primarily or entirely adjacent the upper frame.

### SUMMARY OF THE INVENTION

The invention provides a 4-post workpiece lifting workstation adapted for sports vehicles and small equipment with a cuboid frame structure having a horizontally oriented upper rectangular frame, and four vertically oriented legs each one depending at an upper end from a respective corner of said rectangular frame adapted to maintain said rectangular frame in an elevated horizontal position, wherein the lower end of each leg is independent of said cuboid frame structure, and a generally horizontally disposed work platform within said cuboid frame structure adapted for raising and lowering a workpiece within said cuboid frame structure from a shop floor to and from elevated working positions.

The invention also provides an upper rectangular frame with an internal open area.

The invention also provides a work platform movingly supported on said legs with a pair of parallel support rails each one extending between a separate pair of said legs, and, a pair of parallel workpiece runways supported on said rails between said pairs of legs.

Further, the invention provides cuboid frame structure with a workpiece loading end and workpiece runways with loading ramps at said loading end extending to the exterior of the said cuboid frame structure.

The invention also provides a work platform with at least one workpiece runways secured to the rails for lateral displacement from the other.

The invention also provides a lifting point on the upper frame point adapted to secure means to lift one end or side of a workpiece in relation to the runways.

And the invention provides a cuboid frame structure with one of rails being discontinuous between its pair of legs to provide workpiece access.

### BRIEF DESCRIPTION OF THE DRAWINGS

FIG. 1 is a perspective view of the workpiece lift of the preferred embodiment.

FIG. 2 is a top plan view of the embodiment of the 4-post lift of FIG. 1, across line A-A.

FIG. 3 is a side elevation of the embodiment of the 4-post lift of FIG. 1, across line B-B.

FIG. 4 is a top plan view of the runway elevation along line A-A in FIG. 2.

FIG. 5 is a side elevation along line B-B in FIG. 4.

FIG. 6 is an end elevation of the alternative embodiment of the invention in FIG. 4.

FIG. 7 is a top plan view of an adjustable width embodiment of the invention with roller supports.

FIG. 8 is a partial vertical section of the adjustable runway of FIG. 7 taken along line C-C with runway supported rollers.

FIG. 9 is a partial vertical section of a further adjustable width embodiment of the invention with rail supported rollers.

FIG. 10 is a partial vertical section of a further adjustable width embodiment of the invention with a sliding runway with positioning flanges.

FIG. 11 is a partial sectional view of the embodiment of FIG. 7 including compressible supports for the adjustable runway.

FIG. 12 is a partial perspective view of an optional lift mobility tool as applied to each corner post of the embodiments of FIGS. 1 through 11.

### DETAILED DESCRIPTION OF THE PREFERRED EMBODIMENT

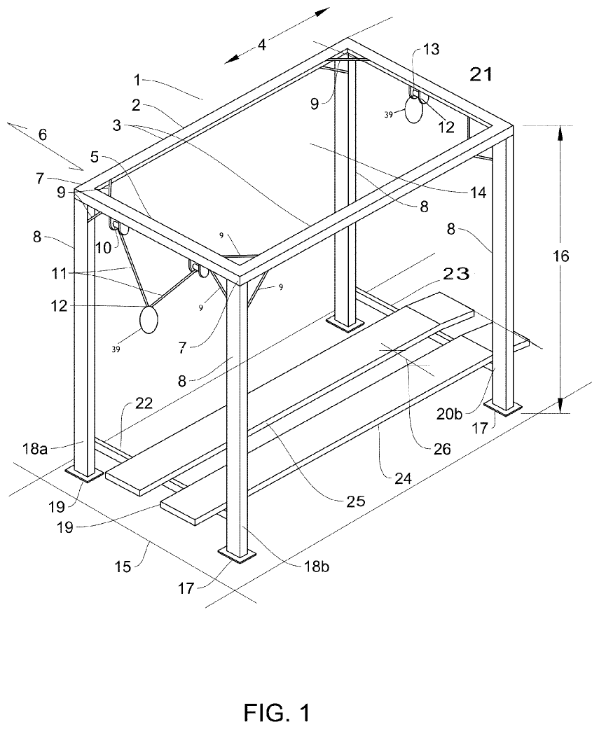

FIG. 1 shows a schematic perspective view of the preferred embodiment of the 4-post lift of the invention 1. Lift 1 includes an upper elongated generally horizontal rectangular frame 2 with peripheral spaced apart axial frame members 3 each generally aligned along equipment axis 4. Rectangular frame 2 is completed with peripheral spaced apart transverse frame members 5 each generally aligned transverse to equipment axis 4 along transverse axis 6 preferably to form an open area within the frame 2.

Each corner 7 of rectangular frame 2 is secured to and supported upon a vertical corner post structure 8 forming a cuboid frame structure, preferably including braces 9 restraining excess bending at upper corners 7. In the preferred embodiment each corner post is independent of the others but for its respective connection at this upper end to the rectangular frame 2. Preferably the lower end of each post structure 8 is not otherwise unitary with the cuboid frame structure.

Preferably, upper rectangular frame 2 is open to the work piece or vehicle as at 14 so as not to interfere with the work piece as it may be lifted into an elevated position for ease of access.

Optionally, one or both of transverse frame members 5 include either:
spaced apart fixed attachment points 10 adapted to secure lifting cables 11 in the form of a lifting sling and a lifting hoist or simple hook point 12 to transverse rail 5 adjacent opposing corners 7. or
singular attachment point 13 adapted to secure hoist or simple hook point 12 directly to transverse rail 5. Attachment point 13 may be fixed, or free to roll along transverse frame member 5 to keep vertical alignment with vertical load from the workpiece.

Each of corner posts 8 extend vertically upwards from shop floor 15, preferably a fixed distance 16, and engage with upper rectangular frame 2 at corners 7 respectively.

Each corner post 8 may be fitted with a floor plate 17 which may be fixed to floor plane 15, or not fixed, allowing the lift structure to be raised off the floor onto quick mount casters (FIG. 12), or both, for selective movement of the 4-post lift 1 across the shop floor. A transverse rail 22 is slidingly connected to posts 8 at lift end 19 as at carriages or sliding blocks 18a and 18b.

A transverse rail 23 is connected to opposing posts 8 at loading or entry end 21 at carriages or sliding blocks 20a and 20b. Coordinated vertical movement on carriage or sliding block pairs 18 and 20 elevate and lower a work piece by raising and lowering transverse rails 22 and 23.

Each of transverse rails 22 and 23 support at least one and preferably a pair of axially aligned, as at axis 4, first and second workpiece runways 24 and 25 respectively.

Most preferably runway 24 is fixed in its transverse position while second runway 25 is either or both of adjustable in its transverse position, and/or removable, in respect of first runway 24 as at adjustable spacing 26 to accommodate workpieces such as motorcycles and/or ATVs as well as lawn equipment, snowblowers, tractors and the like. Runway 25 is preferably adjustable by means of a sliding or rolling mechanism on each end completed by a track or sliding surface on transverse rails 22 and 23 over a travelling section 26a of runway 25. Each of runways 24 and 25 may be fitted with an entry ramp 27 at the lift entry end 21 to ease transition of a workpiece, such as vehicle 28, onto and off the lift 1 in the axial direction 4.

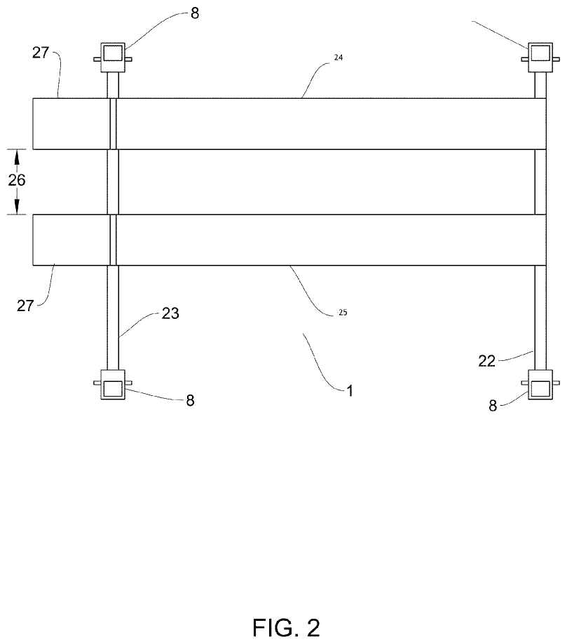

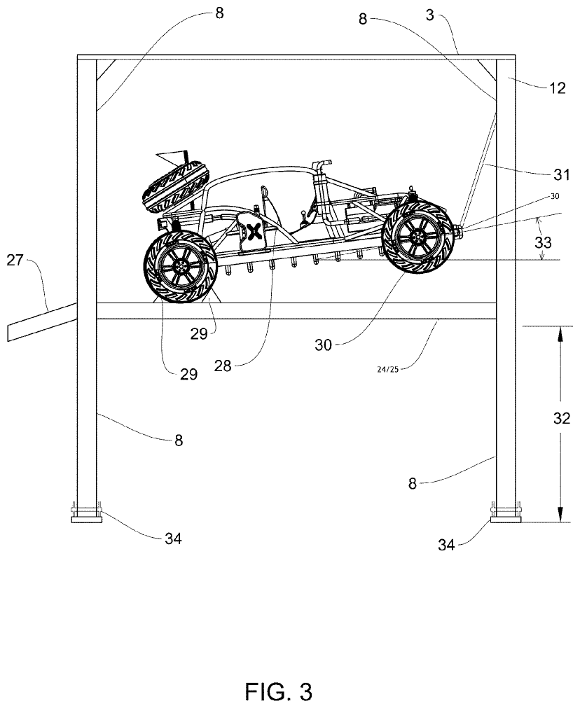

As shown in FIGS. 2 and 3, a workpiece such as vehicle 28 may be positioned on lifting runways 24 and 25 and raised a vertical distance 32 to a comfortable side access level as shown, or lifted higher for under-body access. Optionally, activation of a chain hoist type of device 39 between the vehicle 28 and attachment point 12 on the upper rectangular frame permits the workpiece 28 to be tilted up by connection between frame member 5, chain hoist 36 and vehicle 28 along line 31 as at vehicle point 30. The chain hoist type of device can provide for:
a tilt angle 33 providing even further under-body access without having to raise the workpiece beyond height 32, and
lift of the runway at that end of the workpiece without use of jacks.

Alternatively, the same lift at one end of the workpiece, angle 33, can be provided by connecting anchor point 12 and lift point 30 along line 31 and lowering the lift runways.

Lifting occurs by means of a single or two-stage hydraulic cylinder and cable/pulley combination (not shown), preferably located within the runways, posts, rails and or upper frame members for a uniform lift height of, preferably, no more than 6 feet above the shop floor.

Preferably. wheel chocks 29 are employed to restrain accidental axial motion of vehicle 28.

As shown in FIG. 3 each post 8 may be fitted with an adjustable base plate 34 adapted to accommodate uneven shop floors 15 and/or a set of rollers (not shown).

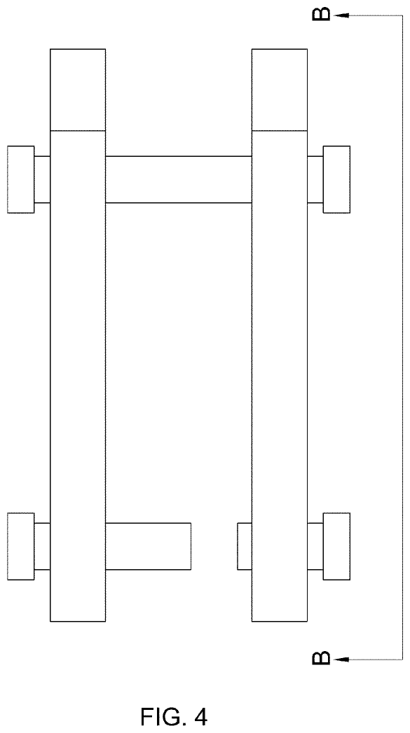

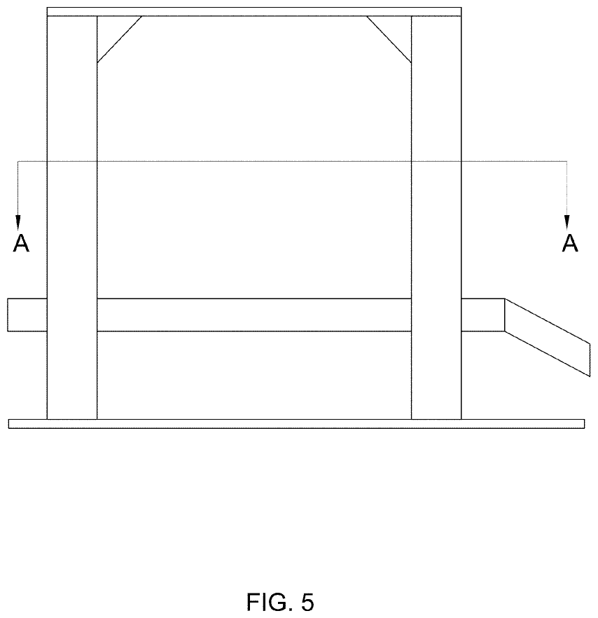

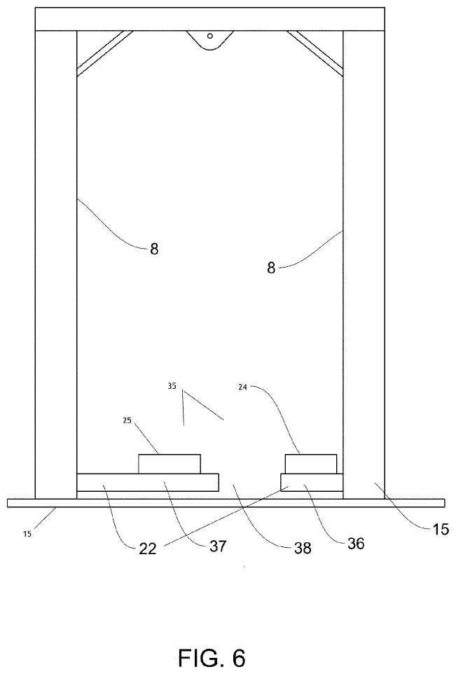

An alternative embodiment is shown in FIGS. 4, 5 and 6 in which lift end transverse rail 22 is adapted as at 35 to have 2 horizontally aligned separate portions, namely a fixed length portion 36 and a collapsible/extendable length portion 37 so as to provide for an improved work access passageway 38 between runways 24 and 25 at least at one end of 4-post lift 1.

FIG. 7 is a top plan view of an additional embodiment of the invention 40 which includes a horizontally disposed runway 42 fixedly secured to fore and aft rails 48 (direction 57) and adapted to restrain the separation and twisting between fore and aft rails 49. Ramps 46 provide for workpiece loading on to rails 48 when lowered.

Movable ramp 43 is paired with fixed ramp 42 for a inter-ramp separation 47 between centerlines 44 and 45. Ramp 43 is adapted to be laterally movable along direction 58 so as to remain parallel to fixed ramp 42, preferably when the ramps are fully lowered and unloaded.

Moveable ramp is preferably supported on a pair of transverse elongated roller support rails 49 each respectively secured to a corresponding rail 48.

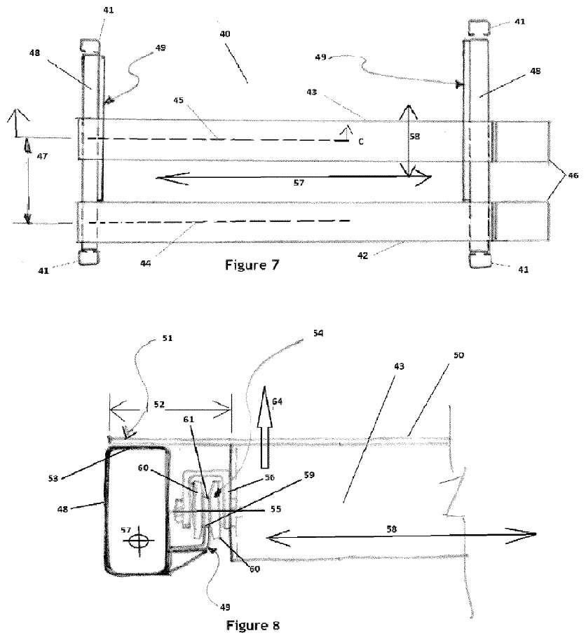

FIG. 8 shows a partial cross-section of the ramp and rail support of FIG. 7. Ramp 43 top surface 50 is extended a distance 52 to cover its corresponding rail 48 for a sliding fit, preferably an interference fit, as at 53.

Roller support rail 49 supports at least a pair of rollers 54 each secured to the body of runway 43 as at 56. Opposing flanges 60 secured roller 2 support axle 61 so as to engage with roller support rail 48 and vertically support runway 43 as at 59. Preferably roller flanges engage with roller support rail as at 59 so secured against longitudinal displacement between runway 43 and rail 48 when in use.

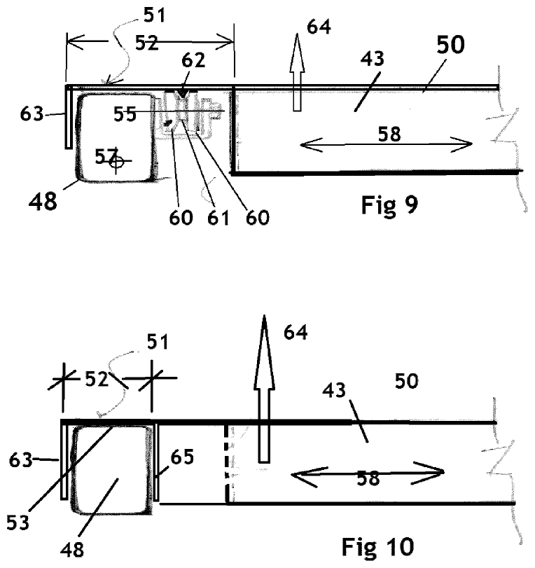

In FIG. 9 a further embodiment of the moveable roller support of FIGS. 7 is provided. In FIG. 9 ramp top surface 50 is supported on roller flanges 60 and roller axle 61 each secured directly to rail 48 for transverse rotation about longitudinal axis 55. Preferably ramp top surface 50 includes detent 62 which engages with roller flanges 60 and core 61 for vertical support of ramp 43 in direction 64.

In FIG. 10 runway 43 and extension 51 engage rail 48 fore and aft for vertical support in direction 64 and preventing longitudinal displacement between them along direction 58. Ramp top surface 50 engages rail top surface for a friction interference fit as at 53 for sliding lateral movement when unloaded.

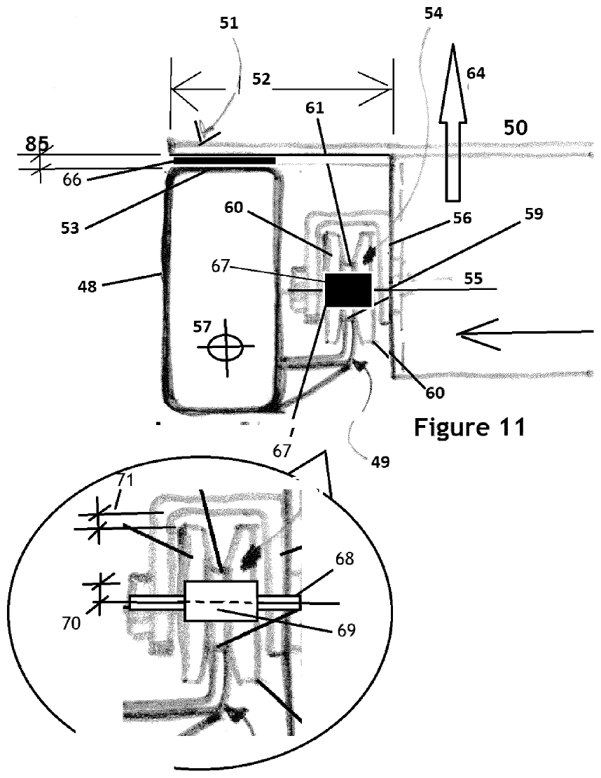

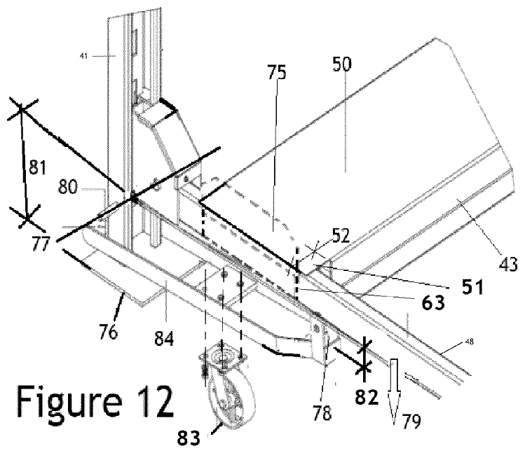

In FIG. 11 a further embodiment of the runway support of FIG. 7 is shown. Ramp top surface 50 extends as at 51 a distance 52 sufficient to cover transverse rail 48 but is supported on roller 56 so as to provide a gap 85 between top surface extension 51 and rail top surface 53.

Rollers 60 and roller support axle include a compressible cylindrical axle component 67 co-rotating about axis 55. Upon loading the ramp 43 compressible component 67 is compressed until extension 51 comes into an interference fit 53 with rail 48 so as to restrain relative movement between rail 48 and runway 43. Preferably, gap 85 is fitted with a metallic or compressible washer 66 adapted to further secured runway top 50 against relative movement. Optionally, fit 53 may include opposing pairs of teeth to further secure the runway 43 to the rail 48.

FIG. 12 shows 1 of a pair of lifting engagements which lift each leg baseplate 76 clear of the floor once runways 42 and 43 are fully lowered. Runway top extension 51 may be provided with depending flange 63 and an upstanding flange 75 adapted to prevent workpiece drift off the end of runways 42 and 43. As rails 48 are lowered (direction 79) thereby reducing spacing 81 towards its lowest point lever arm 84 pivots about pin 80 engaged to post 41 around axis 77 by upwards force provided by caster wheel 83 engaging the floor. As lowering of rail 48 raises base plate 76 from the floor permitting free movement of the lift structure on its 4 posts 41 and its 4 caster wheels 83. Similarly, raising rails 48 lowers base plate 76 into floor engagement for use of the workpiece lift.

Although some embodiments have been described herein, it should be understood that these embodiments are provided for illustration only and are not to be construed in any way as limiting the present invention, and that various modifications, changes, and alterations can be made by those skilled in the art without departing from the spirit and scope of the invention.

### LIST OF ELEMENTS

preferred embodiment
upper rectangular frame
axial frame member
axis of equipment
transverse frame member
transverse axis
corner of upper frame
corner post structure
corner gussets
spaced apart attachment points
lifting cables
chain hoist
singular attachment point, fixed or rolling
open to work piece
shop floor
fixed vertical distance
floor plate
carriage or sliding block
18a and 18b lift end (aft) carriage or sliding block pair
19 lift end
20a and 20b lift entry (for) carriage or sliding block pair
21 lift entry end
22 lift end transverse rail
23 lift entry transverse rail
24 first, fixed runway
25 second, adjustable runway
26 adjustable runway spacing
26a travelling section of runway 25
27 ramps
28 vehicle
29 optional chocks
30 vehicle hitch or anchor point
31 tilt line of force
32 lift height-vertical
33 angle of vehicle tilt
34 adjustable base plate
35 surface section covered by moveable runway 25
36 fixed portion of rail 22
37 collapsible/extendable portion of rail 22
38 passageway
39 chain hoist

### LIST OF ELEMENTS—PER FIGS. 7 TO 12

40 embodiment
41 corner posts
42 fixed runway
43 laterally adjustable runway
44 runway centerline
45 runway centerline
46 entry ramps—separate
47 distance—centerline to centerline
48 lift rails
49 roller support
50 runway top surface
51 runway extension flange
52 overlap distance
53 rail top—flat surface
54 roller—1 of several
55 axis of rotation of roller 54
56 roller secured to body of runway 43
57 lift entry axis
58 lift transverse axis 4 of FIG. 1
59 vertical support of runway on rail between roller axle 61 and rail 49
60 roller flanges
61 roller support axle
62 transverse runway guide—detent
63 guide flange
64 runway support direction
65 runway extension abuts rail for sliding fit
66 compressible friction mat
67 compressible roller axle
68 metal roller axle
69 compressible roller axle sleeve
70 radius of compressible roller sleeve
71 reducible gap between flange 51 and rail 48
75 stop
76 base plate
77 pivot axis
78 catchment
79 downward direction
80 pivot axle
81 height of rail above floor
82 catchment distance
83 castering wheel
84 lever arm
85 gap

1. A four post workpiece lifting workstation adapted for sports vehicles and small equipment comprising:
a) a cuboid frame structure comprising:
i) a horizontally oriented upper rectangular frame, and
ii) four vertically oriented legs each one depending at an upper end from a respective corner of said rectangular frame adapted to maintain said rectangular frame in an elevated horizontal position,
iii) wherein the lower end of each leg is independent of said cuboid frame structure, and
b) a generally horizontally disposed work platform within said cuboid frame structure adapted for raising and lowering a workpiece within said cuboid frame structure from a shop floor to and from elevated working positions.

2. The four post workpiece lifting workstation as claimed in claim 1, wherein said upper rectangular frame includes an open area.

3. (canceled)

4. The four post workpiece lifting workstation as claimed in claim 1, wherein said work platform includes:
a) a pair of parallel support rails each one extending between a separate pair of said legs, and,
b) a pair of parallel workpiece runways supported on said rails between said pairs of legs.

5. The four post workpiece lifting workstation as claimed in claim 4, wherein said cuboid frame structure includes a workpiece loading end and said runways each include workpiece loading ramps at said loading end.

6. The A four post workpiece lifting workstation as claimed in claim 5, wherein said loading ramps extend to the exterior of the said cuboid frame structure.

7. The four post workpiece lifting workstation as claimed in claim 5, wherein at least one of said runways is secured to said rails for lateral displacement from the other of said runways.

8. The four post workpiece lifting workstation as claimed in claim 1, wherein said rectangular frame includes at least one lifting point adapted to secure means to lift one end or side of a workpiece in relation to said runways.

9. The four post workpiece lifting workstation as claimed in claim 4, wherein one of said rails is not continuous between its respective rails.

10. A four post workpiece lifting workstation adapted for sports vehicles and small equipment including a generally horizontally disposed work platform within said four posts adapted for raising and lowering a workpiece from a shop floor to and from elevated working positions wherein said work platform comprises:
a) a pair of parallel support rails each one extending between a separated pair of said posts, and,
b) a pair of parallel workpiece runways each separately supported on said rails between said pairs of posts, and wherein:
i) a first one of said runways is fixedly supported on said rails and supports the workstation, and,
ii) a second one of said runways is moveably supported on said rails and adapted to provide for an adjustable spacing between said runways when in use.

11. The four post workpiece lifting workstation as claimed in claim 1, wherein said second one of said runways is slidably supported on at least one of said rails.

12. The four post workpiece lifting workstation as claimed in claim 11, wherein said second one of said runways is supported on at least one of said rails by a rolling carriage.

13. The four post workpiece lifting workstation as claimed in claim 12, wherein at least one of said rails include a rolling track adapted to provide or contain a rolling support for said runway.

14. The four post workpiece lifting workstation as claimed in claim 13, wherein at least one of said rails and/or said second one of said runways include at least one moving fence adapted to confine movement between said second one of said runways and said rails to motion perpendicular to said second one of said runways.

15. The four post workpiece lifting workstation as claimed in claim 13, wherein said movable runway locks in to a position parallel to the fixedly supported runway when in use.

16. The four post workpiece lifting workstation as claimed in claims 1, wherein one of said rails is not continuous between its pair of said legs.

17. A four post workpiece lifting workstation as claimed in claim 2, wherein said upper rectangular frame includes peripheral spaced apart frame members aligned along the equipment axis and spaced apart transverse frame members aligned transverse to the equipment axis.

18. A four post workpiece lifting workstation as claimed in claim 17, wherein said work platform is movingly supported on said legs.
